(19) United States
(12) Patent Application Publication
(10) Pub. No.: US 2026/0143247 A1
(43) Pub. Date: May 21, 2026

(54) IMAGING APPARATUS, IMAGING METHOD, AND PROGRAM

(71) Applicant: Japan Display Inc., Tokyo (JP)

(72) Inventors: Hirondo NAKATOGAWA, Tokyo (JP); Yoshiro AOKI, Tokyo (JP)

(73) Assignee: Japan Display Inc., Tokyo (JP)

(21) Appl. No.: 19/390,713

(22) Filed: Nov. 17, 2025

(30) Foreign Application Priority Data
Nov. 20, 2024 (JP) 2024-202279

(51) Int. Cl. H04N 23/95

(52) U.S. Cl. CPC H04N 23/95

(57) ABSTRACT

An imaging apparatus includes a liquid crystal panel (LCP), an optical system, an imaging element (IE), a memory, and a controller. The LCP selectively forms a first and a second geometric patterns. The optical system forms an image of light from a subject on a light-receiving surface of the IE. The IE converts the light from the subject that has passed through the LCP and the optical system into an electrical signal to obtain image data. The controller controls the LCP and the IE such that exposure and reading of image data into the memory in the IE are started in synchronization with a time point when a first time period has elapsed from a start of switching of a geometric pattern in the LCP, and switching of the geometric pattern in the LCP is started in synchronization with completion of reading of the image data into the memory.

### CROSS-REFERENCE TO RELATED APPLICATION

The present application claims priority to Japanese Patent Application No. 2024-202279 filed on Nov. 20, 2024, the disclosure of which is incorporated herein by reference.

### BACKGROUND

The present disclosure relates to an imaging apparatus, an imaging method, and a program.

In the field of coded imaging, a technique called Depth From Defocus (DFD) is known. The DFD technique is a technique for estimating the distance from an optical assembly of an imaging apparatus to a subject, that is, the depth or front-to-back distance of the subject, based on the degree of blurring of edges appearing in an image obtained by imaging.

The DFD technique is described, for example, in “Coded Aperture Pairs for Depth from Defocus and Defocus Deblurring” C. Zhou, S. Lin and S. K. Nayar, International Journal of Computer Vision, Vol. 93, No. 1, pp. 53, May. 2011. (Non-Patent Document 1). In the DFD technique, coded imaging is performed in which a mask, referred to as a coded aperture, is disposed in a light-incident region of an optical assembly to image an image of a subject. Then, decoding processing based on a point spread function that is unique to the mask is performed on the imaged image obtained by the coded imaging, and the front-to-back distance of the subject is estimated. The point spread function is generally referred to as “PSF”, and is also called a blur function, a blur spread function, or a point image distribution function.

### SUMMARY

The DFD technique is still under development, and there remains much room for improvement in terms of practicality. In view of the above circumstances, a DFD technique with higher practicality is desired.

Among the disclosures disclosed in the present application, an outline of representative ones is described as follows.

According to one embodiment of representative present disclosure, an imaging apparatus includes a liquid crystal panel, an optical assembly, an imaging element, a storage unit, and a control unit, wherein the liquid crystal panel receives control from the control unit, selectively forms a first geometric pattern and a second geometric pattern, and limits a transmission region of light from a subject, wherein the optical assembly forms an image of the light from the subject on a light-receiving surface of the imaging element, wherein the imaging element converts the light from the subject that has passed through the liquid crystal panel and the optical assembly into an electrical signal to obtain image data, and wherein the control unit controls the liquid crystal panel and the imaging element such that exposure and reading of the image data into the storage unit in the imaging element are started in synchronization with a time point when a first time period has elapsed from a start of switching of the geometric pattern in the liquid crystal panel, and switching of the geometric pattern in the liquid crystal panel is started in synchronization with completion of the reading of the image data into the storage unit.

Further, according to embodiment of one representative present disclosure, an imaging method includes receiving, by a liquid crystal panel, control from a control unit, selectively forming a first geometric pattern and a second geometric pattern, and limiting a transmission region of light from a subject, forming, by an optical assembly, an image of the light from the subject on a light-receiving surface of an imaging element, converting, by the imaging element, the light from the subject that has passed through the liquid crystal panel and the optical assembly into an electrical signal to obtain image data, and controlling, by the control unit, the liquid crystal panel and the imaging element such that exposure and reading of the image data into a storage unit in the imaging element are started in synchronization with a time point when a first time period has elapsed from a start of switching of the geometric pattern in the liquid crystal panel, and switching of the geometric pattern in the liquid crystal panel is started in synchronization with completion of reading of the image data into the storage unit.

Further, according to one embodiment of representative present disclosure, a program used in an imaging apparatus includes a liquid crystal panel, an optical assembly, an imaging element, a storage unit, and a control unit, the imaging apparatus in which the imaging apparatus causes the liquid crystal panel to receive control from the control unit, to selectively form a first geometric pattern and a second geometric pattern, and to limit a transmission region of light from a subject, the optical assembly to form an image of the light from the subject on a light-receiving surface of the imaging element, the imaging element to convert the light from the subject that has passed through the liquid crystal panel and the optical assembly into an electrical signal to obtain image data, and the control unit to control the liquid crystal panel and the imaging element such that exposure and reading of the image data into a storage unit in the imaging element are started in synchronization with a time point when a first time period has elapsed from a start of switching of the geometric pattern in the liquid crystal panel, and switching of the geometric pattern in the liquid crystal panel is started in synchronization with completion of reading of the image data into the storage unit, in which the program causing a processor to function as the control unit.

### BRIEF DESCRIPTION OF THE DRAWINGS

FIG. 1 is a diagram illustrating an installation example of an imaging system according to a first embodiment.

FIG. 2 is a diagram illustrating an example of a configuration of the imaging system.

FIG. 3 is a diagram illustrating a configuration example of an arithmetic processing control unit by functional blocks.

FIG. 4 is a diagram illustrating a configuration example of the arithmetic processing control unit by hardware.

FIG. 5 is a flowchart illustrating a processing flow in the imaging system according to the first embodiment.

FIG. 6 is a diagram illustrating a configuration example of an imaging element.

FIG. 7 is a diagram illustrating an example of a timing chart of signals in the imaging element according to an imaging method of the first embodiment.

FIG. 8 is a diagram illustrating an example of a timing chart of signals in the imaging element according to a reference imaging method.

### DETAILED DESCRIPTION

Before describing embodiments of the present disclosure, the basic concept of the DFD technique and the background of examination by the present inventors will be described.

An imaging apparatus includes, for example, an arithmetic control processing unit, an optical assembly, an imaging element, and a liquid crystal panel. The liquid crystal panel is a light-transmissive liquid crystal panel having a plurality of transparent electrodes. The arithmetic control processing unit controls voltages applied to the respective transparent electrodes of the liquid crystal panel so as to change a geometric pattern formed by a light-shielding region and a light-transmission region into a desired pattern. The liquid crystal panel thus functions as a plurality of masks (coded apertures) necessary for coded imaging. Light incoming from a subject forms an image on a light-receiving surface of the imaging element through the liquid crystal panel and the optical assembly.

The arithmetic control processing unit controls such that a geometric pattern formed on the liquid crystal panel alternately switches between a first pattern (first coded aperture) and a second pattern (second coded aperture). The arithmetic control processing unit repeatedly reads image data from the imaging element and sequentially stores the image data. The arithmetic control processing unit stores image data read during a period in which the first pattern is formed on the liquid crystal panel as first image data, and stores image data read during a period in which the second pattern is formed on the liquid crystal panel as second image data. Based on the latest obtained first image data and second image data, the arithmetic control processing unit performs image data processing including decoding processing using a point spread function, and generates a depth map of the subject.

As described above, when image data are read while the geometric pattern of the liquid crystal panel is being switched, a method can be considered in which the switching control of the geometric pattern and the control of image data reading are performed independently of each other, and image data processing is performed when the necessary image data have been obtained. Hereinafter, this method will be referred to as a reference imaging method.

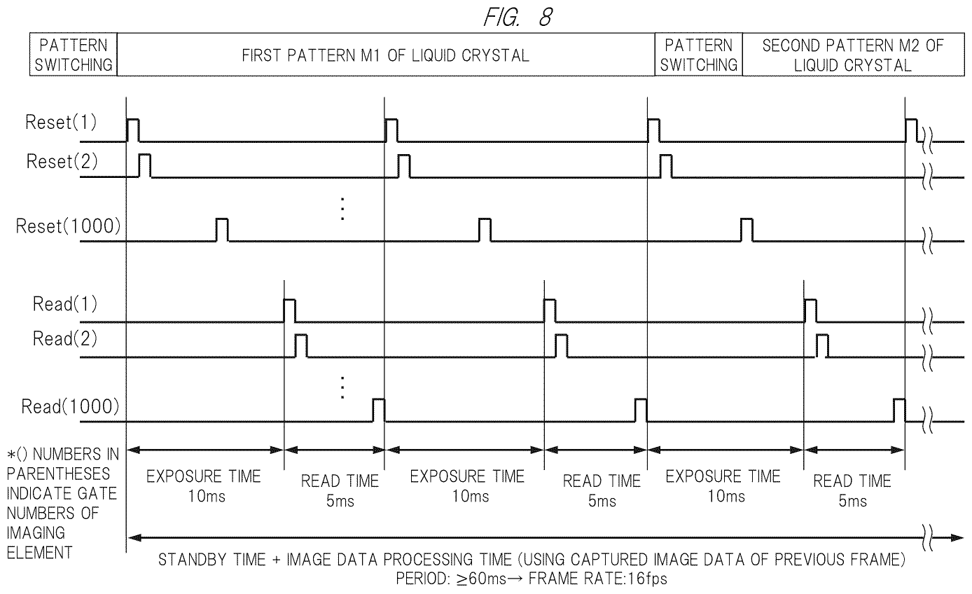

FIG. 8 is a diagram illustrating an example of a timing chart of signals in the imaging element according to the reference imaging method. In the timing chart illustrated in FIG. 8, “Reset( )” represents a signal input to a reset signal line of each pixel sensor in the imaging element, and “Read( )” represents a signal input to a read signal line of each pixel sensor. These signals are input on a pixel-row basis in a pixel array. The number in parentheses indicates a gate number in the pixel array, that is, a pixel-row number. The example illustrated in FIG. 8 assumes that gate numbers exist from 1 to 1000.

In the liquid crystal panel, formation of a first geometric pattern (hereinafter also referred to as a first pattern) M1 and formation of a second geometric pattern (hereinafter also referred to as a second pattern) M2 are alternately performed. It should be noted that switching between the patterns requires a certain amount of time. Pulse signals are sequentially input to signal lines Reset(1) through Reset(1000). As a result, each pixel sensor is reset. Subsequently, pulse signals are sequentially input to signal lines Read(1) through Read(1000). Accordingly, each pixel sensor 3011 outputs an analog signal Vsig corresponding to the exposure light amount. The time from input of the pulse signal to the signal line Reset(1) to input of the pulse signal to the signal line Read(1) corresponds to the exposure time. The exposure time is, for example, 10 milliseconds (ms).

The time from when the input of a pulse signal to the signal line Read(1) is started until the input of the pulse signal to the signal line Read(1000) is completed corresponds to the read time of image data by the imaging element with the first pattern M1. The read time is, for example, 5 ms.

In this manner, while the pattern switching is performed in parallel, control is repeatedly executed in which pulse signals are sequentially input to the signal lines Reset(1) through Reset(1000), and pulse signals are sequentially input to the signal lines Read(1) through Read(1000). When one frame of image data most recently acquired, that is, the image data with the first pattern M1 and the image data with the second pattern M2, has been obtained, predetermined image data processing is performed, and new image data, such as a depth map of the subject, is obtained.

In the case of the reference imaging method, in order to ensure that the image data with the first pattern M1 and the image data with the second pattern M2 can be reliably read, it is necessary to perform exposure and image data reading at least twice within a period having the same period as that in which one geometric pattern is formed. Accordingly, regarding image data processing, the sum of the standby time and the image data processing time becomes 60 ms or more in the above example. That is, one frame of image data is acquired at a period of approximately 60 ms, and the frame rate becomes 16 fps (frames per second).

The time required for exposure and image data reading can be made relatively short by configuring the arithmetic control processing unit as an integrated circuit to enable high-speed operation. According to the reference imaging method, there is an advantage in that control does not become complicated and stable operation is easily achieved.

Meanwhile, when the amount of light incident on the light-receiving surface of the imaging element is sufficient, image data representing a bright image suitable for generating a depth map can be obtained even if the exposure time is set to the intended time period. However, for example, when the subject is located in a dark place, or when the light-transmission regions of the geometric pattern formed on the liquid crystal panel is narrow, the amount of light incident on the light-imaging element becomes receiving surface of the relatively small. When the amount of light incident on the light-receiving surface is small, it is necessary to set the exposure time longer than the intended time period so that image data representing a bright image suitable for generating a depth map can be obtained.

In the reference imaging method described above, the period during which one geometric pattern is formed needs to be twice or more as long as the time required for exposure and image data reading. Accordingly, when the exposure time becomes longer, the time required for exposure and image data reading also becomes longer, and therefore, the period during which one geometric pattern is formed must be made longer. Furthermore, the amount of extra time other than one cycle of exposure and image data reading increases, resulting in a decrease in frame rate. When the frame rate decreases, in processing that uses the generated time-series depth maps, sufficient information may not be obtained.

In view of the above circumstances and as a result of conducted extensive research, the present inventors conceived the present disclosure. Hereinafter, embodiments of the present disclosure will be described. It should be noted that the embodiments described below are merely examples for implementing the present disclosure and are not intended to limit the technical scope of the present disclosure. In the following embodiments, components having the same functions are denoted by the same reference numerals, and repeated explanations thereof will be omitted unless particularly necessary.

### First Embodiment

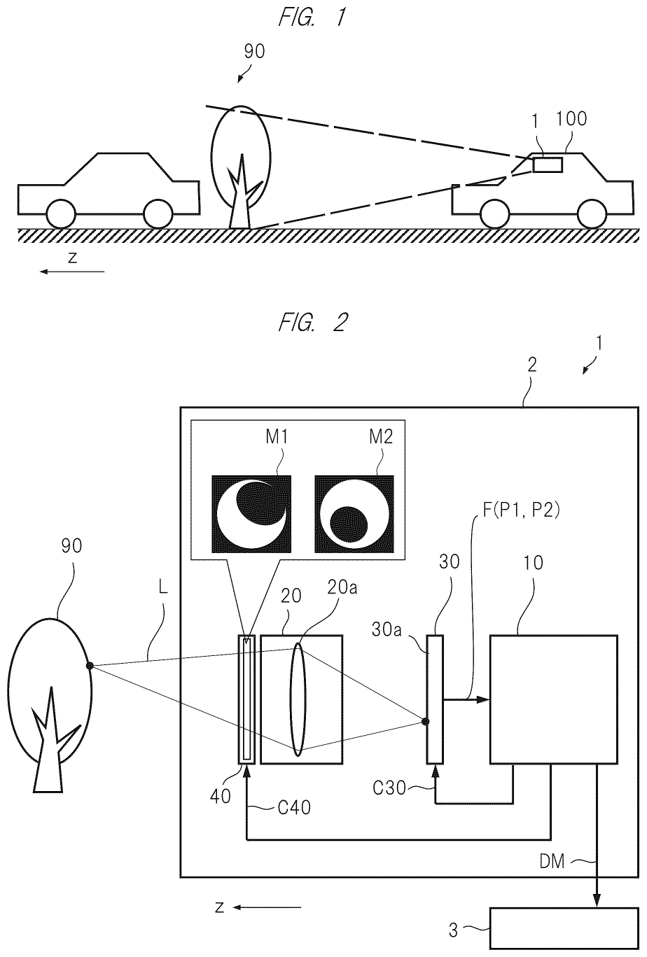

FIG. 1 is a diagram illustrating an installation example of an imaging system 1 according to a first embodiment. As illustrated in FIG. 1, the imaging system 1 is installed in an automobile 100 serving as a vehicle. The imaging system 1 is configured to image a subject 90 located in front of the automobile 100. In the drawing, a z-direction represents the traveling direction of the automobile 100 on forward side. It should be noted that the imaging system 1 may be configured to image a subject located not only in front of the vehicle but also in other directions, such as rearward or sideways.

### Configuration Example of Imaging System According to First Embodiment

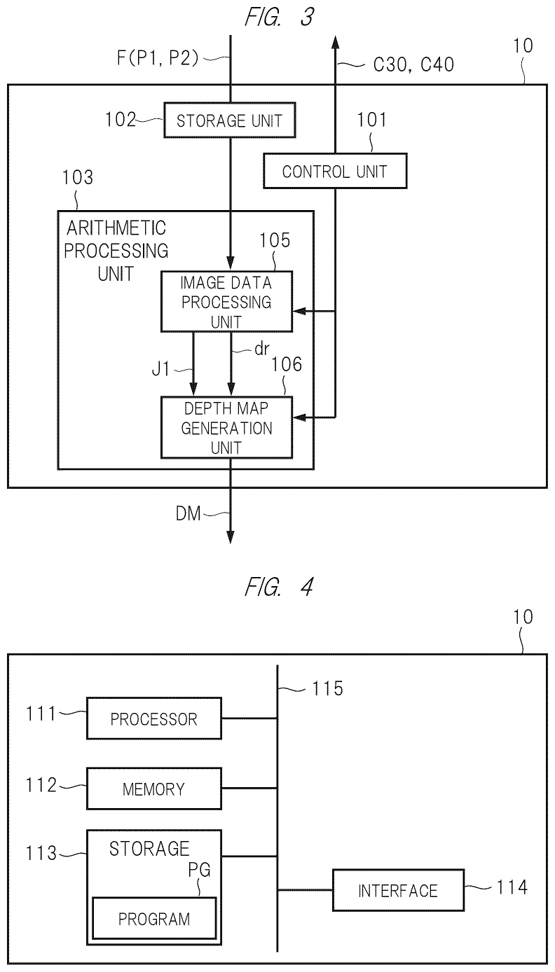

FIG. 2 is a diagram illustrating an example of a configuration of the imaging system 1. As illustrated in FIG. 2, the imaging system 1 includes an imaging apparatus 2 and an external apparatus 3. The imaging apparatus 2 and the external apparatus 3 are electrically connected to each other and are capable of mutual communication. The external apparatus 3 is, for example, a driving-assistance device of the vehicle. The driving-assistance device includes, for example, a collision-mitigation braking function, a cruise-control function for following a preceding vehicle speed, a lane-departure suppression function, a sudden-start suppression function, and the like.

The imaging apparatus 2 includes an arithmetic control processing unit 10, an optical assembly 20, an imaging element 30, and a liquid crystal panel 40. Here, the combination of the optical assembly 20, the imaging element 30, and the liquid crystal panel 40 is referred to as an imaging system. The imaging element 30 is electrically connected to the arithmetic control processing unit 10, and the liquid crystal panel 40 is also electrically connected to the arithmetic control processing unit 10.

The optical assembly 20 condenses light incident from the subject 90 onto a light-receiving surface 30a of the imaging element 30 to form an image. The optical assembly 20 includes, for example, a lens 20a. The lens 20a may be a single lens or a compound lens, and may be a fixed-focus lens or a zoom lens.

The imaging element 30 has the light-receiving surface 30a, which is constituted by a plurality of photoelectric conversion elements disposed two-dimensionally. The imaging element 30 converts light L, which passes through the liquid crystal panel 40 and the optical assembly 20 and is received on the light-receiving surface 30a, into an electrical signal corresponding to its intensity, and outputs image data based on the electrical signal to the arithmetic control processing unit 10. Alternatively, the imaging element 30 may output the photoelectrically converted electrical signal to the arithmetic control processing unit 10, and the arithmetic control processing unit 10 may obtain image data based on the electrical signal. The imaging element 30 is also referred to as an image sensor. The imaging element 30 is, for example, a CMOS-type image sensor.

The liquid crystal panel 40 does not include a backlight. The liquid crystal panel 40 functions as a filter for light that enters the optical assembly 20 from the subject 90 and reaches the imaging element 30. The liquid crystal panel 40 can selectively form a first geometric pattern M1 and a second geometric pattern M2 by controlling voltages applied to electrodes. These geometric patterns form a light-shielding region and a light-transmission region, thereby limiting a transmission region of light L from the subject 90. In the first embodiment, the liquid crystal panel 40 is disposed between the optical assembly 20 and the subject 90. However, the liquid crystal panel 40 may alternatively be disposed between the optical assembly 20 and the imaging element 30.

The first geometric pattern M1 and the second geometric pattern M2 function, for example, as two types of masks used for coded imaging. The mask is also referred to as a coded aperture. That is, the first geometric pattern M1 and the second geometric pattern M2 correspond to a first coded aperture and a second coded aperture, respectively. In the first embodiment, a case is assumed in which the first and second geometric patterns M1 and M2 are used as masks for coded imaging. The first geometric pattern M1 is also referred to as a first pattern, and the second geometric pattern M2 is also referred to as a second pattern.

### Configuration Example of Arithmetic Processing Control Unit

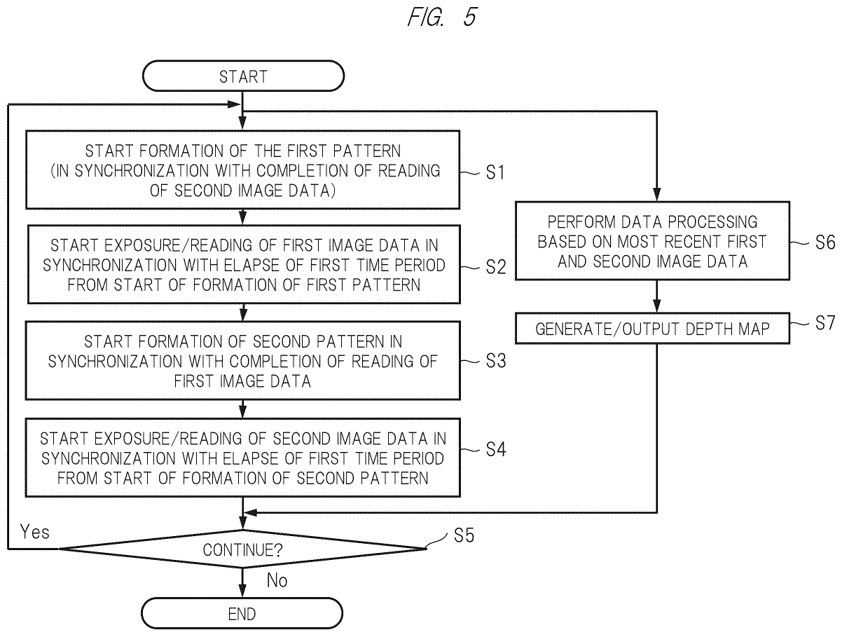

FIG. 3 is a diagram illustrating a configuration example of the arithmetic processing control unit by functional blocks. As illustrated in FIG. 3, the arithmetic control processing unit 10 includes a control unit 101, a storage unit 102, and an arithmetic processing unit 103. The arithmetic processing unit 103 includes an image data processing unit 105 and a depth map generation unit 106.

The control unit 101 causes first image data P1 corresponding to the first pattern M1 and second image data P2 corresponding to the second pattern M2 to be read from the imaging element 30 into the storage unit 102. Here, the first image data P1 and the second image data P2 obtained in temporal proximity are referred to as one frame of imaged image data F.

The control unit 101 transmits a control signal C40 to the liquid crystal panel 40 and a control signal C30 to the imaging element 30 so that one frame of imaged image data F can be repeatedly read in plurality of times. That is, the control unit 101 controls the liquid crystal panel 40 and the imaging element 30 such that a series of operations is repeatedly performed, in which the liquid crystal panel 40 forms the first pattern M1, the light-receiving surface 30a of the imaging element 30 is exposed to light L from the subject 90, the first image data P1 is read, the liquid crystal panel 40 forms the second pattern M2, the light-receiving surface 30a of the imaging element 30 is exposed to light L from the subject 90, and the second image data P2 is read.

Here, the control unit 101 controls the liquid crystal panel 40 and the imaging element 30 such that, after the first time period T1 has elapsed from the start of switching of the geometric pattern in the liquid crystal panel 40, exposure and reading of image data into the storage unit 102 in the imaging element 30 are started in synchronization, and switching of the geometric pattern in the liquid panel is crystal 40 started in synchronization with the completion of the reading of image data into the storage unit 102. The first time period T1 is, for example, a time required from the start to the completion of switching of the geometric pattern in the liquid crystal panel 40. In practice, the first time period T1 is a time obtained by adding a slight margin to the required time for switching of the geometric pattern. The margin may be, for example, about 5% to 20% of the required time for switching of the geometric pattern.

By such synchronization control performed by the control unit 101, even when the exposure time: in the imaging element 30 becomes relatively long, the imaged image data F can be repeatedly read in a time-efficient manner. A case in which the exposure time becomes relatively long includes, for example, a case where the light-shielding region of the geometric pattern formed on the liquid crystal panel 40 is wide, or where the surroundings are dark and the amount of light from the subject 90 is small, so that it is desired to increase the amount of light received by the imaging element 30.

The image data processing unit 105 performs image data processing including decoding processing using a point spread function of the imaging system each time one frame of imaged image data F is read into the storage unit 102, that is, each time one frame of coded imaging is performed. In the first embodiment, the image data processing unit 105 performs decoding processing on the imaged image data F to obtain a subject image J1 without blur, representing the subject 90, and a depth dr at each position of the subject 90 corresponding to each pixel of the subject image J1. The depth dr at each position refers to the distance from the imaging system to each position of the subject 90.

The depth map generation unit 106 generates, as third image data, a depth map DM of the subject 90 based on the subject image J1 and the depth dr at each position of the subject 90. The depth map DM is a map representing the depth at each position of the subject 90. The arithmetic processing unit 103 transmits the generated depth map DM to the external apparatus 3.

FIG. 4 is a diagram illustrating a configuration example of the arithmetic processing control unit by hardware. As illustrated in FIG. 4, the arithmetic control processing unit 10 includes a processor 111, a memory 112, a storage 113, an interface 114, and a communication bus 115. The processor 111, the memory 112, the storage 113, and the interface 114 are connected to the communication bus 115. The processor 111 is, for example, a central processing unit (CPU), a microprocessor (MPU), or a microcontroller (MCU). The memory 112 is, for example, a semiconductor memory such as a RAM, a ROM, or an EEPROM. The storage 113 is, for example, a storage device such as a hard disk drive (HDD) or a solid-state drive (SSD). The interface 114 is a connection portion for external devices and performs input and output of data with the external devices.

A program PG is stored in the memory 112 or the storage 113. The processor 111 reads out the program PG, loads it into the memory 112, and executes it so as to function, in cooperation with other devices, as various functional blocks. In the first embodiment, the processor 111 functions as each of the functional blocks from the control unit 101 to the depth map generation unit 106. The storage 113 may be omitted, and the program PG may be stored in the memory 112. Further, a part or all of the components from the processor 111 to the interface 114 may be formed as an integrated circuit, that is, may be implemented as a single chip.

### <Processing Flow in Imaging System>

FIG. 5 is a flowchart illustrating a processing flow in the imaging system according to the first embodiment. As illustrated in FIG. 5, the flowchart includes Steps S1 to S7. The processes from Step S1 to Step S4 and the processes from Step S6 to Step S7 are performed in parallel.

First, in Step S1, a process of forming a first pattern in a liquid crystal panel is performed. Specifically, the liquid crystal panel 40 receives the control signal C40 from the control unit 101 and starts forming, in the liquid crystal panel 40, an image representing a first pattern M1. When the execution of the step is the second or later time, the liquid crystal panel 40 starts switching the pattern formed therein from the second pattern M2 to the first pattern M1 in synchronization with the timing when reading of second image data P2 corresponding to the second pattern M2 is completed.

Next, in Step S2, processing is performed to start exposure and reading of image data in synchronization with the time point when the first time period T1 has elapsed from the start of formation of the first pattern. Specifically, the imaging element 30, upon receiving the control signal C30 from the control unit 101, starts exposure on the light-receiving surface 30a with light L from the subject 90 in synchronization with the time point when the first time period T1 has elapsed from the start of formation of the first pattern M1. Then, in synchronization with the time point when the set exposure time has elapsed, the imaging element 30 starts outputting the first image data P1, and the storage unit 102 starts reading the first image data P1.

Subsequently, in Step S3, switching of the pattern to be formed from the first pattern M1 to the second pattern M2 is started in synchronization with the completion of reading of the first image data P1. Specifically, the liquid crystal panel 40, upon receiving the control signal C40 from the control unit 101, starts switching the pattern formed on the liquid crystal panel 40 from the first pattern M1 to the second pattern M2 in synchronization with the time point when the reading of the first image data P1 is completed.

Then, in Step S4, processing is performed to start exposure and reading of image data in synchronization with the time point when the first time period T1 has elapsed from the start of formation of the second pattern. Specifically, the imaging element 30, upon receiving the control signal C30 from the control unit 101, starts exposure on the light-receiving surface 30a with light L from the subject 90 in synchronization with the time point when the first time period T1 has elapsed from the start of formation of the second pattern M2. Then, in synchronization with the time point when the set exposure time has elapsed, the imaging element 30 starts outputting the second image data P2, and the storage unit 102 starts reading the second image data P2.

Meanwhile, while the processing from Step S1 to Step S4 is being performed, Step S6 to Step S7 are executed in parallel.

In Step S6, image data processing is performed based on the most recently obtained first image data and second image data. Specifically, the image data processing unit 105 performs image data processing on the most recently obtained first image data P1 and second image data P2, which are stored in the storage unit 102. The image data processing includes decoding processing using a point spread function corresponding to the imaging system. Through the image data processing, the image data processing unit 105 obtains an image of the subject 90 without blur and a depth dr at each position of the subject 90 corresponding to each pixel constituting the image of the subject 90.

In Step S7, processing for generating and outputting a depth map is performed. Specifically, the depth map generation unit 106 generates, as third image data, a depth map DM of the subject 90 based on the image of the subject 90 and the depth dr at each position of the subject 90, and outputs the depth map DM to the external apparatus 3.

After execution of Step S4 and Step S7, Step S5 is performed to determine whether to continue the processing. Specifically, the control unit 101 determines whether to continue the processing based on factors such as the presence or absence of an error in the imaging apparatus 2 and the presence or absence of a command to stop the processing. If it is determined in the determination that the processing is to be continued (S5: Yes), the processing steps return to Step S1 and Step S6, and the processing continues. On the other hand, if it is determined that the processing is not to be continued (S5: No), the processing ends.

### Configuration Example of Imaging Element

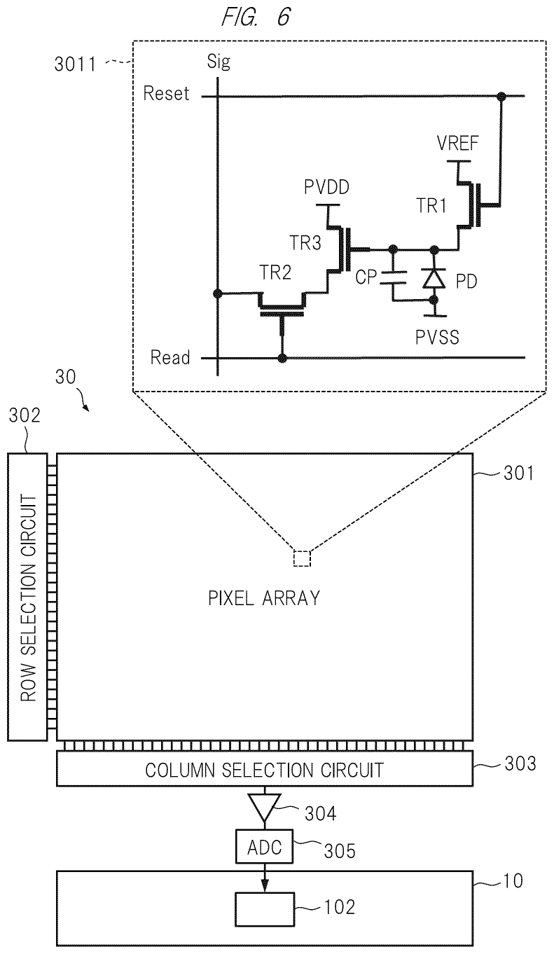

FIG. 6 is a diagram illustrating a configuration example of the imaging element. As illustrated in FIG. 6, the imaging element 30 includes a pixel array 301, a row selection circuit 302, a column selection circuit 303, an amplifier 304, and an analog-to-digital converter (ADC) 305. The pixel array 301 is constituted by a plurality of pixel sensors 3011 arranged in a matrix.

Each pixel sensor 3011 includes three transistors and a photodiode PD. The three transistors are a reset transistor TR1, a row selection transistor TR2, and an amplifying transistor TR3. In the basic operation of the pixel sensor, first, a pulse signal is input to the signal line Reset to turn on the reset transistor TR1, thereby resetting the photodiode PD. Next, when the photodiode PD is exposed to light L from the subject 90, an electric charge corresponding to the exposure time is generated by photoelectric conversion. The generated electric charge is accumulated in a capacitor CP, and the potential of the capacitor CP changes. Then, a pulse signal is input to the signal line Read to turn on the row selection transistor TR2, and the potential of the capacitor CP is read out by the source follower of the amplifying transistor TR3 and obtained from the signal line Sig as a signal Vsig.

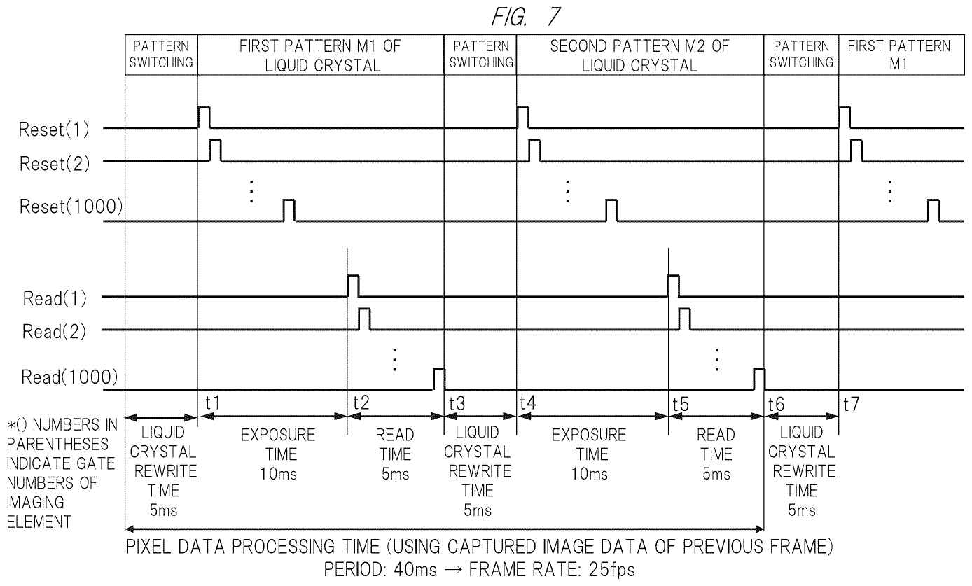

The row selection circuit 302 selects a gate number of a pixel row in the pixel array 301 to be a target for signal reading, and sequentially inputs pulse signals to the signal line Reset and the signal line Read with a time interval corresponding to the exposure time. At the timing when a pulse signal is input to the signal line Read, the row selection circuit 302 sequentially selects pixel columns of the pixel array 301 and acquires signals of the respective pixels constituting the target pixel row. The acquired signals are amplified by the amplifier 304, converted from analog signals into digital signals by the analog-to-digital converter 305, and read into and stored in the storage unit 102. The row selection circuit 302 sequentially shifts the gate number of the target pixel row to select another pixel row, and the series of operations described above is repeated. As a result, signals of the respective pixel sensors 3011 constituting the pixel array 301 are acquired on a row-by-row basis. FIG. 7 is a diagram illustrating an example of a timing chart of signals in the imaging element according to the imaging method of the first embodiment. In the timing chart illustrated in FIG. 7, “Reset( )” represents a signal input to a reset signal line of each pixel sensor, and “Read( )” represents a signal input to a read signal line of each pixel sensor. These signals are input on a pixel-row basis in the pixel array 301. The number in parentheses indicates a gate number in the pixel array 301, that is, a pixel-row number. The example illustrated in FIG. 7 assumes a case where gate numbers exist from 1 to 1000.

At the time point t1, which is after the first time period T1 has elapsed from the start of formation of the first pattern M1 in the liquid crystal panel 40, the pattern switching from the second pattern M2 to the first pattern M1 has already been completed. In synchronization with the time point t1, pulse signals are sequentially input to the signal lines Reset(1) through Reset(1000). As a result, each pixel sensor 3011 is reset. The period from the time point t1 to the time point t2, when the second time period T2 has elapsed from the time point t1, corresponds to the exposure time of the imaging element 30 with the first pattern M1. The exposure time is, for example, 10 milliseconds (ms).

Subsequently, in synchronization with the time point t2, when the exposure time has elapsed from the time point t1 at which the pattern switching was completed, pulse signals are sequentially input to the signal lines Read(1) through Read(1000). As a result, an analog signal Vsig corresponding to the exposure light amount is output from each pixel sensor 3011. The time from the time point t2, when input of the pulse signal to the signal line Read(1) is started, to the time point t3, when input of the pulse signal to the signal line Read(1000) is completed, corresponds to the read time of the first image data P1 by the imaging element 30 with the first pattern M1. The read time is, for example, 5 ms.

Subsequently, in synchronization with the time point t3, when the reading of the first image data P1 with the first pattern M1 is completed, formation of the second pattern M2 in the liquid crystal panel 40 is started. At the time point t4, which is after the first time period T1 has elapsed from the start of formation of the second pattern M2 in the liquid crystal panel 40, the pattern switching from the first pattern M1 to the second pattern M2 has already been completed. The time from the time point t3 to the time point t4 corresponds to the liquid crystal rewriting time. The liquid crystal rewriting time is, for example, 5 ms.

Subsequently, in synchronization with the time point t4, when the first time period T1 has elapsed from the start of formation of the second pattern M2, pulse signals are sequentially input to the signal lines Reset(1) through Reset(1000). As a result, each pixel sensor 3011 is reset. The period from the time point t4 to the time point t5, when the second time period T2 has elapsed, corresponds to the exposure time of the imaging element 30 with the second pattern M2. The exposure time is, for example, 10 ms, as in the case of the first pattern M1. The exposure time may be controlled according to the amount of light incident on the light-receiving surface 30a of the imaging element 30, that is, the pixel array 301, or may be fixed.

Subsequently, in synchronization with the time point t5, when the exposure time has elapsed from the time point t4 at which the pattern switching was completed, pulse signals are sequentially input to the signal lines Read(1) through Read(1000). As a result, an analog signal Vsig corresponding to the exposure light amount is output from each pixel sensor 3011. The time from the time point t5, when the input of a pulse signal to the signal line Read(1) is started, to the time point t6, when the input of a pulse signal to the signal line Read(1000) is completed, corresponds to the read time of the second image data P2 by the imaging element 30 with the second pattern M2. The exposure time is, for example, 5 ms, as in the case of the first pattern M1.

Subsequently, in synchronization with the time point t6, when the reading of the second image data P2 with the second pattern M2 is completed, formation of the first pattern M1 in the liquid crystal panel 40 is started. At the time point t7, which is after the first time period T1 has elapsed from the start of formation of the first pattern M1 in the liquid crystal panel 40, the pattern switching from the second pattern M2 to the first pattern M1 has already been completed. The time from the time point t6 to the time point t7 corresponds to the liquid crystal rewriting time. The exposure time is, for example, 5 ms, as in the case of the first pattern M1.

As described above, during the period from the time point t1 to the time point t6, pulse signals are input to the signal line Reset( ) and to the signal line Read( ) at predetermined timings. By repeatedly performing such input of pulse signals, the first image data P1 obtained by imaging with the first pattern M1 and the second image data P2 obtained by imaging with the second pattern M2 are alternately acquired. The first image data P1 and the second image data P2 acquired in temporal proximity constitute one frame of image data.

During the period from the start of formation of the first pattern M1 (or from the completion of reading of the second image data P2 of the previous frame) to the time point t6, predetermined image data processing is performed on the most recently acquired previous one frame of image data, that is, the first image data P1 and the second image data P2, and new third image data P3 is obtained. That is, the timing at which the second image data P2 is acquired is the time point t6, and the arithmetic operation starts from the time point t6. In other words, the arithmetic operation starts at the start of the pattern switching period before the time point t1 and ends at the time point t6. In the first embodiment, the third image data P3 is a depth map of the subject 90. The period from the start of formation of first pattern M1 (or from the completion of reading of the second image data P2 of the previous frame) to the time point t6 corresponds to the image data processing time. In the above example, the image data processing time is 40 ms. That is, one frame of image data is acquired at a period of 40 ms, and the frame rate is 25 fps (frames per second).

According to the first embodiment, the control unit 101 in the imaging apparatus 2 controls the liquid crystal panel and the imaging element such that, after the first time period T1 has elapsed from the start of switching of the geometric pattern in the liquid crystal panel 40, exposure in the imaging element 30 is started, followed by reading of image data into the storage unit 102, and switching of the geometric pattern in the liquid crystal panel 40 is started in synchronization with the completion of reading of the image data into the storage unit 102.

By this control performed by the control unit 101, the timing of completion of pattern switching in the liquid crystal panel 40 and the timing of starting exposure and reading of image data are synchronized. Accordingly, even when a longer exposure time is required for the imaging element 30, unnecessary exposure and data reading are eliminated, and the image data required for image data processing can be read in a time-efficient manner. That is, when the subject 90 is imaged while switching the geometric pattern of the liquid crystal panel 40, the first and second image data P1 and P2 corresponding to each geometric pattern can be obtained in a shorter time.

As a result, the frame rate of image data reading can be increased, and the number of depth maps of the subject 90 generated per unit time can be increased.

### Modified Example

In the first embodiment, stereo imaging may be performed instead of coded imaging. In the modified example, the first geometric pattern M1 and the second geometric pattern M2 formed in the liquid crystal panel 40 function as two types of apertures used for stereo imaging, that is, a first aperture and a second aperture. The two types of apertures used for stereo imaging are apertures having mutually different positions with respect to the imaging element 30. The image data processing unit 105 performs image processing on the imaged image data F using a triangulation method to obtain a subject image J1 without blur representing the subject 90 and a depth dr at each position of the subject 90 corresponding to each pixel of the subject image J1.

As a result, the frame rate of image data reading can be increased, and the number of depth maps of the subject 90 generated per unit time can be increased.

### Other Embodiments

As described above, the imaging system according to the first embodiment has been described. However, an imaging method following the processing flow of the imaging system 1 is also one embodiment of the present disclosure.

Furthermore, a program for causing a processor to function as the control unit 101 in the first embodiment, and a tangible non-transitory storage medium storing the program, are also embodiments of the present disclosure.

Although various embodiments of the present disclosure have been described above, the present disclosure is not limited to the embodiments described above and can be modified in various manners. Further, the numerical values and the like included in the text and figures are merely examples, and using different numerical values and the like does not compromise the effects of the present disclosure.

For example, in the above embodiment, the imaging system 1 is described as being installed in an automobile. However, the imaging system 1 may be installed in vehicles other than automobiles, such as trains or monorails, motorcycles, bicycles, ships, or airplanes. Even in such installation examples, the imaging system 1 provides the same effects as in the above embodiments and can be used, for example, for driving-assistance techniques. The imaging system 1 may also be used independently without being mounted on a vehicle.

What is claimed is:

1. An imaging apparatus comprising:
a liquid crystal panel, an optical assembly, an imaging element, a storage unit, and a control unit,
wherein the liquid crystal panel receives control from the control unit, selectively forms a first geometric pattern and a second geometric pattern, and limits a transmission region of light from a subject,
wherein the optical assembly forms an image of the light from the subject on a light-receiving surface of the imaging element,
wherein the imaging element converts the light from the subject that has passed through the liquid crystal panel and the optical assembly into an electrical signal to obtain image data, and
wherein the control unit controls the liquid crystal panel and the imaging element such that exposure and reading of the image data into the storage unit in the imaging element are started in synchronization with a time point when a first time period has elapsed from a start of switching of the geometric pattern in the liquid crystal panel, and switching of the geometric pattern in the liquid crystal panel is started in synchronization with completion of the reading of the image data into the storage unit.

2. The imaging apparatus according to claim 1, further comprising
an arithmetic processing unit,
wherein the arithmetic processing unit generates third image data by performing image data processing based on first image data corresponding to the first geometric pattern and second image data corresponding to the second geometric pattern, the first image data and the second image data being most recently obtained and read into the storage unit.

3. The imaging apparatus according to claim 1,
wherein the first time period is a time required from a start to completion of switching of the geometric pattern.

4. The imaging apparatus according to claim 2,
wherein the arithmetic processing unit performs the image data processing 1 while exposure and reading of image data with the first geometric pattern, switching from the first geometric pattern to the second geometric pattern, exposure and reading of image data with the second geometric pattern, and switching from the second geometric pattern to the first geometric pattern are being performed.

5. The imaging apparatus according to claim 1,
wherein the first geometric pattern and the second geometric pattern correspond to a first coded aperture and a second coded aperture that are different from each other.

6. The imaging apparatus according to claim 1,
wherein the first geometric pattern and the second geometric pattern correspond to a first aperture and a second aperture having openings at mutually different positions with respect to the imaging element.

7. The imaging apparatus according to claim 2,
wherein the third image data represents a depth map of the subject.

8. The imaging apparatus according to claim 1,
the imaging apparatus is mounted on a vehicle, and
the subject is located in front of the vehicle.

9. An imaging method comprising:
receiving, by a liquid crystal panel, control from a control unit, selectively forming a first geometric pattern and a second geometric pattern, and limiting a transmission region of light from a subject;
forming, by an optical assembly, an image of the light from the subject on a light-receiving surface of an imaging element;
converting, by the imaging element, the light from the subject that has passed through the liquid crystal panel and the optical assembly into an electrical signal to obtain image data; and
controlling, by the control unit, the liquid crystal panel and the imaging element such that exposure and reading of the image data into a storage unit in the imaging element are started in synchronization with a time point when a first time period has elapsed from a start of switching of the geometric pattern in the liquid crystal panel, and switching of the geometric pattern in the liquid crystal panel is started in synchronization with completion of reading of the image data into the storage unit.

10. The imaging method according to claim 9,
wherein an arithmetic processing unit generates third image data by performing image data processing based on first image data corresponding to the first geometric pattern and second image data corresponding to the second geometric pattern, the first image data and the second image data being most recently obtained and stored in the storage unit.

11. The imaging method according to claim 9,
wherein the first time period is a time required from a start to completion of switching of the geometric pattern.

12. The imaging method according to claim 10,
wherein the arithmetic processing unit performs the image data processing in parallel while exposure and reading of image data with the first geometric pattern, switching from the first geometric pattern to the second geometric pattern, exposure and reading of image data with the second geometric pattern, and switching from the second geometric pattern to the first geometric pattern are being performed.

13. The imaging method according to claim 9,
wherein the first geometric pattern and the second geometric pattern correspond to a first coded aperture and a second coded aperture that are different from each other.

14. The imaging method according to claim 9,
wherein the first geometric pattern and the second geometric pattern correspond to a first aperture and a second aperture having openings at mutually different positions with respect to the imaging element.

15. The imaging method according to claim 10,
wherein the third image data represents a depth map of the subject.

16. The imaging method according to claim 9,
wherein the imaging element is mounted on a vehicle, and
the subject is located in front of the vehicle.

17. A program used in an imaging apparatus including
a liquid crystal panel, an optical assembly, an imaging element, a storage unit, and a control unit, the imaging apparatus
wherein the imaging apparatus causes
the liquid crystal panel to receive control from the control unit, to selectively form a first geometric pattern and a second geometric pattern, and to limit a transmission region of light from a subject,
the optical assembly to form an image of the light from the subject on a light-receiving surface of the imaging element,
the imaging element to convert the light from the subject that has passed through the liquid crystal panel and the optical assembly into an electrical signal to obtain image data, and
the control unit to control the liquid crystal panel and the imaging element such that exposure and reading of the image data into a storage unit in the imaging element are started in synchronization with a time point when a first time period has elapsed from a start of switching of the geometric pattern in the liquid crystal panel, and switching of the geometric pattern in the liquid crystal panel is started in synchronization with completion of reading of the image data into the storage unit,
wherein the program causing a processor to function as the control unit.

18. The program according to claim 17,
wherein the imaging apparatus includes an arithmetic processing unit,
the arithmetic processing unit generates third image data by performing image data processing based on first image data corresponding to the first geometric pattern and second image data corresponding to the second geometric pattern, the first image data and the second image data being most recently obtained and stored in the storage unit, and
wherein the program causes the processor to function as the arithmetic processing unit.
